(19) United States
(12) Patent Application Publication
(10) Pub. No.: US 2021/0386087 A1
(43) Pub. Date: Dec. 16, 2021

(54) TILAPIA OIL OR ITS FRACTIONATED PRODUCTS AND METHOD OF USE THEREOF

(71) Applicant: Jiangnan University, Wuxi City (CN)

(72) Inventors: Xiaosan WANG, Wuxi City (CN); Xinyi CHENG, Wuxi City (CN); Zhuangzhuang YANG, Wuxi City (CN); Cong JIANG, Wuxi City (CN); Jianhua HUANG, Wuxi City (CN); Ruijie LIU, Wuxi City (CN); Ming CHANG, Wuxi City (CN)

(21) Appl. No.: 17/214,961

(22) Filed: Mar. 29, 2021

(30) Foreign Application Priority Data
Jun. 16, 2020 (CN) 2020105455507
Dec. 14, 2020 (CN) 2020114713692

(51) Int. Cl. A23D 9/007; A23L 33/00; A23L 33/115; A23K 50/30; A23K 20/158; A23K 20/147

(52) U.S. Cl. CPC A23D 9/007; A23L 33/40; A23K 20/147; A23K 50/30; A23K 20/158; A23L 33/115

(57) ABSTRACT

The present invention provides an application of tilapia oil or fractionated product thereof, which belongs to the technical field of food technology. The applications involve in swine feed, fat for replacing breast milk, or dairy products. The present invention found that palmitic acid, oleic acid and linoleic acid in tilapia oil, and more than 65% of palmitic acid is distributed in sn-2 position, the highest content of triglyceride OPL, can be used as fat additives in swine feed or formula milk powder use oil. Therefore, adding tilapia oil to swine feed or formula milk powder is beneficial to the absorption of fatty acids and calcium, and can improve the absorption and utilization of energy.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCES TO RELATED APPLICATIONS

This application claims priorities from (1) Chinese patent application number 2020105455507 filed on Jun. 16, 2020 and (2) Chinese patent application number 2020114713692 filed on Dec. 14, 2020; the disclosures of which are incorporated herein by reference in their entirety.

### FIELD OF THE INVENTION

The present invention relates to applications of tilapia oil or fractionated products thereof, which belongs to the technical field of food technology.

### BACKGROUND OF THE INVENTION

Adding fat to diet can provide the body with the energy needed for growth and development. Piglets can absorb and utilize milk fat well. 70% of the energy required for their growth and development comes from milk fat. The existing swine feed mostly uses some oily meal or vegetable oil as fat source. These feed fats are difficult for piglets to digest and utilize, leading to steatorrhea, slow growth and high mortality after weaning. The nutritional value of fat is not only related to the length of the fatty acid carbon chain and the number of double bonds, but also depends on the composition and distribution of fatty acids. Studies have shown that saturated fatty acids are more easily absorbed at the sn-2 position than at sn-1 and sn-3 position. The triglycerides of sow milk fat and pig body fat have a unique structure. Saturated fatty acids are preferentially esterified in sn-2 position, unsaturated fatty acids are mainly distributed in sn-1 and 3 positions. The composition of fatty acids in feed is single, and the composition and proportion of fatty acids are seriously unbalanced; In addition, saturated fatty acids are preferentially esterified in sn-1 and 3 position, and the absorption and utilization rate is low, causing the loss of energy and calcium (Jinchao Chen, Effects of Supplementing Diets with Different Chain Lengths of Fatty Acids during Late Pregnancy and Lactation on the Reproductive Performance of Sows and Growth Performance of Suckling Piglets, Master's thesis of Southwest University, 2019). Early weaned piglets have poor resistance and weak digestion ability. The existing feed does not fully conform to the physiological characteristics of piglet digestion and absorption. Therefore, we need to provide them with easy-to-digest and nutritious diets.

Breast milk is generally considered to be the best food for infants. It is rich in nutrients and is easy to be absorbed and utilized, which is conducive to the growth and development of infants. Breast milk contains 3%˜5% fat (mostly water), which is called breast milk fat. It is mainly composed of triglycerides (TAG, about 98%). It not only provides about 50% of the required energy for infants, but also can provide infants with essential fatty acids for growth and development, which plays an important role in the healthy growth of infants. The distribution of fatty acids in breast milk fat on TAG molecule is not random, but has unique distribution characteristics. About 70% of palmitic acids are distributed in sn-2 position of TAG, while unsaturated fatty acids (UFA) are mainly distributed in sn-1,3 position. Therefore, the main TAGs of breast milk fat are 1,3-dioleoyl-2-palmitoylglycerol (OPO) and 1-oleoyl-2-palmitoyl-3-linoleoylglycerol (OPL). The TAG structure is conducive to the absorption of fat and calcium by infants and young children, and prevents the loss of energy and calcium (Donald M S. The effects of glyceride structure on absorption and metabolism, Annual Review of Nutrition, 1991, 11, 413-434).

Infancy is the period of fastest growth and development in one's life. One year after birth, the height of the newborn increases by 25 cm, and the brain weight increases by more than two times. The brain is the most vigorous tissue of breast milk metabolism. At this stage, the metabolism of infants is significantly higher than adults, and they need more energy (Author: [symbol] Title: [symbol] [symbol] [M], publishing house: [symbol] ), Therefore, FAO and WHO recommend that for infants, the energy provided by fat should account for 40% to 60% of the total dietary energy (the recommended value for adults is only 20% to 30%). Therefore, for infants and young children, not only should there be enough fat in the diet, but also this fat structure should be conducive to absorption. OPO and OPL rich in breast milk are conducive to the absorption of infants and young children and are the best triglyceride structure. However, our investigation on the composition of fatty acids, sn-2 fatty acids and triglycerides of commercially available infant milk powder shows that the compositions of sn-2 fatty acids and triglycerides of human milk fat substitutes are quite different from those of breast milk fat. The saturated fatty acids in the triglycerides in the commercially available human milk fat substitutes are in the sn-1 and 3 positions, and the unsaturated fatty acids are in the sn-2 position (Author: [symbol] Title: [symbol] [symbol] [symbol] [symbol] Information: [symbol] [symbol] 2018). Most of the existing commercial infant formula milk powders are vegetable oil-based, and the composition and distribution of vegetable oil are not conducive to the digestion and absorption of infants and young children. In terms of triglyceride composition, only a few human milk fat substitutes are added with OPO structured fat, and little attention has been paid to the addition of OPL structured fat. OPL is the triglyceride with the highest content in breast milk fat in our country. Therefore, adding OPL triglycerides to human milk fat substitutes is the key to improving the quality of infant formula milk powder.

In the prior art, physical blending of different fats and oils can make human milk fat substitutes having high similarity with human milk fat in total fatty acid composition, but it is difficult to obtain highly similar human milk fat substitutes with breast milk fat in sn-2 fatty acid and triglyceride compositions. The best human milk fat substitute is to have its sn-2 fatty acid composition and triglyceride composition similar to breast milk fat. The total fatty acid composition of human milk fat substitutes similar to human milk fat may have a completely different triglyceride molecular structure from human milk fat, which may have adverse effects on digestion and absorption of infants and young children.

### SUMMARY OF THE INVENTION

### Technical Issues

The technical problem to be solved by the present invention is that the existing human milk fat substitute has a low degree of similarity with breast milk fat in terms of sn-2 fatty acid composition and triglyceride composition.

### Technical Proposal

The tilapia oil has high content of palmitic acid, oleic acid and linoleic acid, and more than 65% of total palmitic acid is distributed in sn-2 position, and the highest content of triglyceride is OPL (31.94%). This composition and distribution is conducive to the absorption of fatty acids and calcium in infants or piglets, which can improve the absorption and utilization of energy, improve the hardness of feces, reduce the occurrence of constipation and intestinal diseases in infants, and can be used as fat additive or formula oil in swine feed.

The present invention provides a human milk fat substitute composition, wherein the composition is prepared by using tilapia oil or its fractionated product as a base oil, and adding one or more natural oils and/or modified oils.

In one embodiment, the natural oil is extracted from natural animals and plants.

In one embodiment, the natural oils include one or more of soybean oil, peanut oil, palm oil, palm kernel oil, coconut oil, and basa catfish oil.

In one embodiment, the modified oils include one or more of 1,3-dioleoyl-2-palmitoylglycerol (OPO) structured lipids, 1-oleoyl-2-palmitoyl-3-linoleoylglycerol (OPL) structured lipids, medium-and-long chain triacylglycerol (MLCT) structured lipids.

In one embodiment, the OPO structured lipid is a structured lipid with an OPO content accounting for more than 40% of the total triglyceride content; the OPL structured lipid is a structured lipid with an OPL content accounting for more than 40% of the total triglyceride content, the MLCT structured lipid is a structured lipid whose MLCT content accounts for more than 40% of the total triglyceride content.

In one embodiment, the tilapia oil is extracted by one or more of solvent method or aqueous enzyme method; the tilapia oil fractionated product is obtained by extracting tilapia oil by dry method or solvent method.

In one embodiment, the preparation method of the tilapia oil fractionated products, the extraction solvent used in the solvent fractionation is acetone or n-hexane; the mass-volume ratio (w/v, g/mL) of the tilapia oil and the solvent is 1:(2-10); the extraction temperature is −30˜0° C.; and the extraction time is 10-24 h.

In one embodiment, the human milk fat substitute composition includes: 1%-50% natural fat and/or modified fat and 50%-99% tilapia oil or tilapia oil fractionated product based on mass percentage.

In one embodiment, the human milk fat substitute composition includes: palmitic acid at the sn-2 position accounts for 40% to 70% of the total palmitic acid content, and the sum of OPO and OPL accounts for 30% to 65% of the total triglyceride content; preferably, the palmitic acid at the sn-2 position accounts for 40% to 60% of the total palmitic acid content, and the sum of OPO and OPL accounts for 35% to 55% of the total triglyceride content based on mass percentage.

In one embodiment, the human milk fat substitute composition includes: 1%-20% coconut oil and 80%-99% tilapia oil or tilapia oil fractionated product, preferably, 10%-20% coconut oil and 80%˜90% tilapia oil or tilapia oil fractionated product based on mass percentage.

In one embodiment, the human milk fat substitute composition comprises: 1%-20% palm kernel oil and 80%-99% tilapia oil or tilapia oil fractionated product, preferably, 10%-20% palm kernel oil and 80%˜90% tilapia oil or tilapia oil fractionated product based on mass percentage.

In one embodiment, the human milk fat substitute composition includes: 10%-20% coconut oil, 1%-20% palm oil, and 60%-80% tilapia oil or tilapia oil fractionated product based on mass percentage.

In one embodiment, the human milk fat substitute composition comprises: 10%-20% palm kernel oil, 1%-20% palm oil, and 60%-80% tilapia oil or tilapia oil fractionated product based on mass percentage.

In one embodiment, the human milk fat substitute composition comprises: 10% to 20% coconut oil, 1% to 20% soybean oil, and 60% to 80% tilapia oil or tilapia oil fractionated product, preferably, 10% to 20% coconut oil, 1% to 10% soybean oil, and 70% to 80% tilapia oil or tilapia oil fractionated product based on mass percentage.

In one embodiment, the human milk fat substitute composition comprises: 1%-20% palm kernel oil, 1% to 20% OPO structural fat, and 60% to 80% tilapia oil or tilapia oil fractions, preferably, 10% to 20% palm kernel oil, 1% to 10% OPO structural fat and 70% to 80% tilapia oil or tilapia oil fractionated product based on mass percentage.

In one embodiment, the human milk fat substitute composition comprises: 1% to 20% palm kernel oil, 1% to 20% palm oil, 0 to 10% OPO structural fat, and 50% to 80% tilapia oil or tilapia oil fractionated product, preferably, 10% to 20% palm kernel oil, 10% to 20% palm oil, 0 to 5% OPO structural lipid and 55% to 80% non-fish oil or tilapia oil fractionated product based on mass percentage.

In one embodiment, the human milk fat substitute composition comprises: 0 to 10% peanut oil, 0 to 10% soybean oil, 10% to 20% palm oil, 10% to 20% coconut oil, and 50% to 80% tilapia oil or tilapia oil fractionated product based on mass percentage.

In one embodiment, the human milk fat substitute composition comprises: 0 to 10% soybean oil, 0 to 10% peanut oil, 0 to 10% palm oil, 5% to 15% palm kernel oil, and 0 to 25% modified oil based on mass percentage and 50% to 70% tilapia oil or tilapia oil fractionated product based on mass percentage.

In one embodiment, the human milk fat substitute composition comprises: 0 to 10% soybean oil, 0 to 10% peanut oil, 0 to 10% palm oil, 10% to 20% coconut oil, 0 to 30% basa catfish oil, 0 to 20% OPO structural lipid, 0 to 5% OPL structural lipid and 40% to 70% tilapia oil or tilapia oil fractionated product based on mass percentage.

The present invention provides a method of using tilapia oil or tilapia oil fractionated product in preparation of swine feeds.

In one embodiment, the tilapia oil or its fractionated product is used as a supplementary component of OPO and OPL in the preparation of human milk fat substitutes.

The invention provides a food containing the human milk fat substitute composition.

In one embodiment, the food includes infant milk powder, adult milk powder, middle-aged and elderly milk powder and animal infant milk powder.

The invention provides a method of using tilapia oil or its fractionated product in making swine feed.

In one embodiment, the tilapia oil or tilapia oil fractionated product is used as a fat source in swine feed.

In one embodiment, the tilapia oil or tilapia oil fractionated product is added into swine feed as raw material.

The invention provides a swine feed, which comprises tilapia oil or tilapia oil fractionated product, protein, carbohydrate, mineral and vitamin.

In one embodiment, the protein in the feed comprises one or more of soybean meal, blood meal, fish meal and whey protein meal.

In one embodiment, the carbohydrate in the feed comprises one or more of lactose, whey powder and oligosaccharide.

In one embodiment, the feed comprises: 5% to 15% tilapia oil or tilapia oil fractionated product, 20% to 30% fish meal, 20% to 30% soybean meal, 10% to 20% whey powder, 15% to 25% blood powder, 0 to 1% vitamins and 0 to 1% minerals based on mass percentage.

### Beneficial Effect

(1) The fatty acid, linoleic acid and tilapia oil in the invention are 48.27%, 21.33% and 90.33% respectively. The content of sn-2 palmitic acid in tilapia oil accounts for 65% of the total palmitic acid. This high relative content of sn-2 palmitic acid and high content of OPL are not found in other natural oils. OPL is the highest content of triglyceride in Chinese breast milk fat. The composition and structure of tilapia oil is conducive to the digestion and absorption of lipids, and can be well used in swine feed and formula milk powder.

(2) The swine feed provided by the invention comprises nutrients such as fat, protein, carbohydrate, vitamins, minerals, etc., which is easy to digest and has full nutritional value.

(3) The oil for formula milk powder provided by the present invention (human milk fat substitutes) has a higher similarity with Chinese breast milk fat in terms of total fatty acid, sn-2 fatty acid and triglyceride composition. Especially the similarity score of triglyceride composition and Chinese breast milk fat is above 70 points, which is significantly better than the existing human milk fat substitute products. It solves the problem of low absorption rate of fatty acid and calcium of formula milk powder, improves the absorption and utilization of energy, improves the hardness of feces, reduces the occurrence of infant constipation and intestinal diseases, and is more in line with the needs of infants and young children in China In the invention, the human milk fat substitutes can be prepared only by natural fat. The use of natural oils and tilapia oil for blending can obtain a high similarity of human milk fat substitutes, which greatly reduces the cost.

### DETAILED DESCRIPTION

Below the preferred embodiments of the present invention are described, should be appreciated that preferred embodiment described herein only is used for description and interpretation the present invention, and be not used in qualification the present invention.

The determination of the composition of total fatty acid, sn-2 fatty acid and triglyceride involved in the invention is based on the method adopted in Sun Cong's Doctoral Dissertation (Sun Cong. Composition, similarity evaluation and preparation of human milk fat substitutes [D]: [Doctoral dissertation]. Wuxi: Jiangnan University, 2018). The peak area normalization method was used to complete the quantification, and the standard was used for calibration. The area percentage was converted into the mass percentage, and the content was calculated.

The invention relates to the similarity of the composition of fatty acid, sn-2 fatty acid and triglyceride between human milk fat substitute and Chinese human milk fat. According to the similarity evaluation model of breast milk fat established in Dr. Sun Cong's thesis, the similarity between human milk fat substitutes and human milk fat is evaluated by using the “deduction” principle. The similarity evaluation model of breast milk fat is as follows:

$$\begin{matrix}G = \frac{{G}_{FA} + {G}_{sn - 2 FA} + {G}_{TAG}}{3} & ( 1 ) \\ {G}_{FA / sn - 2 FA / TAG} = {\sum }_{i = 1}^{n} [ ( 1 - \frac{\vert {b}_{i} - {a}_{i} \vert}{{a}_{i}} ) \times 100 ] / n , & ( 2 )\end{matrix}$$

G is the total score of similarity evaluation, and the full score is 100; G_{FA/sn-2FA/TAG} was the similarity score of fatty acids, sn-2 fatty acids or triglycerides; n is the number of total fatty acids or sn-2 fatty acids or triglycerides; bᵢ is the actual value of total fatty acid or sn-2 fatty acid or triglyceride of human milk fat substitutes; aᵢ is the terminal value of total fatty acid or sn-2 fatty acid or triglyceride in breast milk fat, depending on the size of bᵢ.

OPO structural lipids, OPL structural lipids and MLCT (medium and long chain triglyceride) structural lipids were synthesized by enzymatic method in laboratory. Among them, OPO was synthesized by the acidolysis of palm stearin and oleic acid catalyzed by NS40086 lipase, the substrate molar ratio is 1:10, the addition amount of lipase is 10%, the reaction temperature is 60° C., and the reaction time is 4 h; OPL was synthesized by the acidolysis of palm stearin, oleic acid and linoleic acid catalyzed by NS40086 lipase, the molar ratio of the substrate is 1:7:7, the addition amount of NS40086 lipase is 10%, the reaction temperature is 60° C., and the reaction time is 4 h; MLCT structural lipid is rich in transesterification of OPO and OPL oil and coconut oil under the catalysis of NS40086 lipase, the substrate molar ratio is 0.8:1, the addition amount of lipase is 10%, the reaction temperature is 60° C., and the reaction time is 6 h. Other fats and oils are commercially available without instructions.

### Example 1: Extraction of Tilapia Oil by Solvent Method (Chloroform/Methanol)

Tilapia oil was extracted with chloroform methanol as solvent. Fresh tilapia was freeze-dried and crushed. 10 g of crushed powders were obtained, and added with 100 ml of methanol, followed by shaking, and further added with 200 ml of chloroform, then subject to sonication for 20 mins. After that, a clear liquid was obtained after filtration, and added with 100 ml of 0.88% by weight of sodium chloride solution to obtain a mixture. The mixture was centrifuged at 4500 rpm for 10 mins, where the lower fraction was obtained after centrifugation and put in a round bottom flask to remove the solvent by rotary evaporation in order to obtain tilapia oil. The tilapia oil content in freeze-dried fish meal was 23.87%.

### Example 2: Extraction of Tilapia Oil by Solvent Method (n-Hexane)

The tilapia oil was extracted with n-hexane. Fresh tilapia was freeze-dried and crushed. 10 g of the crushed powders were obtained, and added with 100 mL of n-hexane, then subject to sonication for 20 mins, and the fish tissues were removed after suction filtration to collect the filtrate. The filtrate was put in a round bottom flask to remove the solvent by rotary evaporation in order to obtain tilapia oil. The tilapia oil content in freeze-dried fish meal was 18.46%.

### Example 3: Aqueous Enzymatic Extraction of Tilapia Oil

Tilapia oil was extracted by aqueous enzymatic method. Fresh tilapia was freeze-dried and crushed. 10 g of the crushed powders were obtained, and added with 30 mL of ionized water to obtain a solution. The solution was adjusted to pH 9 by adding 10% by weight of KOH, followed by adding 0.6% of alkaline protease. The samples were incubated in a constant-temperature water bath on a shaking bed for enzymolysis at 60° C. for 2 h. Then the enzyme was inactivated at 95° C. for 10 minutes. After centrifugation for 10 minutes, the supernatant was extracted with petroleum ether. After stratification, the upper layer was placed in a round bottom flask to remove petroleum ether by rotary evaporation to obtain tilapia oil. The tilapia oil content in freeze-dried fish meal was 20.88%. The contents of palmitic acid, oleic acid and linoleic acid in total fatty acid composition of tilapia oil were 24.27%, 33.90% and 21.48%, respectively. The content of palmitic acid at the sn-2 position is 48.01%. According to calculations, the palmitic acid at the sn-2 position accounts for more than 65% of the total palmitic acid. The contents of OPL and OPO in total triglycerides were 31.94% and 14.71% respectively. The results show that the content of OPL is higher than that of OPO, which is more suitable to be used in the preparation of Chinese breast milk fat substitutes.

### Example 4: A Preparation Method of Tilapia Oil Fractionated Product

The tilapia oil obtained in example 1 was separated by solvent method. The solvent used was acetone, the ratio of tilapia oil to solvent (w/v) was 1:6, the fractionation temperature was −30° C., and the fractionation time was 16 hours to obtain the tilapia oil fractionated product. The contents of palmitic acid, oleic acid and linoleic acid in the tilapia oil fractionated product were 28.27%, 29.41% and 20.28%. The content of sn-2 palmitic acid in the tilapia oil fractionated product was 50.62%, and thus, the content of sn-2 palmitic acid relative to total palmitic acid was 59.68%. The contents of OPL and OPO in the tilapia oil fractionated product were 34.64% and 25.87% respectively.

The compositions of total fatty acids, sn-2 fatty acids and triglycerides in tilapia oil and tilapia oil fractionated product are shown in table 1 and table 2.

TABLE 1
Fatty acid composition (%) of tilapia oil
and tilapia oil fractionated product

| | | Tilapia oil | | | Tilapia oil |
|---|---|---|---|---|---|
| Total Fatty | Tilapia | fractionated | sn-2 Fatty | Tilapia | fractionated |
| Acids | Oil | product | Acids | Oil | product |
| C10:0 | ND | ND | C10:0 | ND | ND |
| C12:0 | ND | 0.30 | C12:0 | 0.50 | 0.54 |
| C14:0 | 2.97 | 4.13 | C14:0 | 4.22 | 5.44 |
| C16:0 | 24.27 | 28.27 | C16:0 | 48.01 | 50.62 |
| C16:1 | 4.05 | 3.14 | C16:1 | 2.64 | 2.13 |
| C18:0 | 6.01 | 8.73 | C18:0 | 5.69 | 6.40 |
| C18:1 | 33.90 | 29.41 | C18:1 | 16.14 | 13.80 |
| C18:2 | 21.48 | 20.28 | C18:2 | 16.79 | 15.61 |
| C18:3 | 3.53 | 2.34 | C18:3 | ND | ND |

Note:
ND means not detected.

TABLE 2
Triglyceride composition (%) of tilapia
oil and tilapia oil fractionated product

| | | Tilapia oil |
|---|---|---|
| | Tilapia | fractionated |
| Triglycerides | Oil | product |
| LaLaO | ND | ND |
| CaPL | ND | ND |
| LLL | ND | ND |
| LaOL | ND | ND |
| CaPO | ND | ND |
| OLL | 6.47 | 1.41 |
| LPL | 12.93 | 10.89 |
| MOL | 2.93 | 1.96 |
| LaOO | ND | ND |
| POLa | ND | ND |
| OPL | 31.43 | 34.64 |
| PPL | 5.36 | 7.46 |
| MPO | ND | ND |
| OOO | 3.28 | ND |
| OPO | 19.49 | 25.87 |
| PPO | ND | 11.87 |
| POS | ND | 1.69 |

Note:
ND means not detected.

### Example 5: Human Milk Fat Substitute Composition

Coconut oil and tilapia oil prepared in example 1 were selected as base oils. Under different coconut oil and tilapia oil ratios, the similarity of total fatty acids, sn-2 fatty acids and triglycerides of the obtained human milk fat substitute composition with Chinese human milk fat (the score of Chinese human milk fat is 100) are shown in table 3.

The optimal ratio of coconut oil:tilapia oil was 13.80%: 86.20%, the sn-2 palmitic acid content in the obtained human milk fat substitute composition is 41.72%. The content of sn-2 palmitic acid is 62.47% relative to the total palmitic acid. The sum of OPO and OPL accounts for 43.89% of the total triglyceride content. The similarity scores of total fatty acids, sn-2 fatty acids and triglycerides with Chinese breast milk fat were 86.45, 83.89 and 70.59, and the total similarity score was 80.31. Sun Cong determined commercially available human milk fat substitutes in infant formula. The similarity scores of total fatty acids, sn-2 fatty acids and triglycerides with Chinese breast milk fat are 56.12, 33.51 and 17.51, and the total similarity score is 35.72. Compared with the commercial human milk fat substitutes in infant formulas, the prepared human milk fat substitute composition in present invention has higher overall similarity with Chinese human milk fat, and also have higher similarity in sn-2 fatty acid composition and triglyceride composition, which is more conducive to the digestion and absorption of infants and young children.

TABLE 3
The score results of human milk fat substitutes obtained
by different coconut oil and tilapia oil compositions

| | | The | The sum | | | | |
|---|---|---|---|---|---|---|---|
| | | percentage of | of the | | | | |
| | | sn-2 palmitic | contents | score | | | |
| Composition | | acid in total | of OPL | Total | Sn-2 | | Total |
| Coconut | Tilapia | palmitic acid | and OPO | fatty | fatty | Triglyc- | similarity |
| oil | oil | (%) | (%) | acids | acid | eride | score |
| 1% | 99% | 65.71 | 50.42 | 74.88 | 78.78 | 69.86 | 74.51 |
| 10% | 90% | 63.49 | 45.83 | 84.78 | 82.91 | 70.46 | 79.38 |
| 13.80% | 86.20% | 62.47 | 43.89 | 86.45 | 83.89 | 70.59 | 80.31 |
| 20% | 80% | 60.69 | 40.73 | 87.71 | 79.31 | 70.59 | 79.20 |

### Example 6: Human Milk Fat Substitute Composition

The palm kernel oil and tilapia oil fractionated product prepared in example 4 were selected as the base oils. Under different ratios of palm kernel oil and tilapia oil fractionated product, the similarity of total fatty acids, sn-2 fatty acids and triglycerides in human milk fat substitute composition and Chinese breast milk fat are shown in table 4.

The optimum ratio of palm kernel oil:tilapia oil fractionated product was 18.34%: 81.66%, the content of sn-2 palmitic acid in the human milk fat substitute composition was 43.22%, and the content of sn-2 palmitic acid accounted for 58.30% of the total palmitic acid. The sum of OPO and OPL accounted for 49.84% of total triglycerides. The similarity scores of total fatty acids, sn-2 fatty acids and triglycerides with Chinese breast milk fat were 96.41, 82.11 and 83.08, and the total similarity score was 87.20. Sun Cong determined commercially available infant formula milk powder oils. The similarity scores of total fatty acids, sn-2 fatty acids and triglycerides with Chinese breast milk fat are 56.12, 33.51 and 17.51, and the total similarity score is 35.72. Compared with the commercial human milk fat substitutes in infant formulas, the prepared human milk fat substitute composition in present invention has higher overall similarity with Chinese human milk fat, and also have higher similarity in sn-2 fatty acid composition and triglyceride composition.

TABLE 4
Score results of human milk fat substitutes obtained from different
palm kernel oil and tilapia oil fractionated product compositions

| | | The | The sum | | | | |
|---|---|---|---|---|---|---|---|
| | | percentage of | of the | | | | |
| Composition | | sn-2 palmitic | contents | Score | | | |
| Palm | tilapia oil | acid in total | of OPL | Total | Sn-2 | | Total |
| Kernel | fractionated | palmitic acid | and OPO | fatty | fatty | Triglyc- | similarity |
| Oil | product | (%) | (%) | acids | acid | eride | score |
| 1% | 99% | 59.62 | 59.92 | 80.57 | 76.58 | 66.14 | 74.43 |
| 10% | 90% | 58.98 | 54.69 | 93.69 | 79.65 | 77.81 | 83.72 |
| 15% | 85% | 58.61 | 51.77 | 95.62 | 81.35 | 81.38 | 86.12 |
| 18.34% | 81.66% | 58.30 | 49.84 | 96.41 | 82.11 | 83.08 | 87.20 |

### Example 7: Human Milk Fat Substitute Composition

Coconut oil, palm oil and tilapia oil prepared in example 1 were selected as the base oils. Under different ratios of coconut oil, palm oil and tilapia oil, the similarity of total fatty acids, sn-2 fatty acids and triglycerides in human milk fat substitute composition and Chinese human milk fat are shown in table 5.

When the ratio of coconut oil:palm oil:tilapia oil was 15.77%: 19.26%: 64.97%, the content of sn-2 palmitic acid was 34.13%, which accounted for 43.18% of the total palmitic acid. The sum of OPO and OPL accounted for 39.37% of total triglycerides. The similarity scores of total fatty acids, sn-2 fatty acids and triglycerides were 92.73, 78.28 and 76.47 respectively, and the total similarity score was 82.49. Sun Cong determined commercially available infant formula milk powder oils. The similarity scores of total fatty acids, sn-2 fatty acids and triglycerides with Chinese breast milk fat are 56.12, 33.51 and 17.51, and the total similarity score is 35.72. Compared with the commercial human milk fat substitutes in infant formulas, the prepared human milk fat substitute composition in present invention has higher overall similarity with Chinese human milk fat, and also have higher similarity in sn-2 fatty acid composition and triglyceride composition.

TABLE 5
Score results of human milk fat substitutes obtained from different
coconut oil, palm oil and tilapia oil compositions

| | | | The | The sum | | | | |
|---|---|---|---|---|---|---|---|---|
| | | | percentage of | of the | | | | |
| | | | sn-2 palmitic | contents | Score | | | |
| Composition | | | acid in total | of OPL | Total | Sn-2 | | Total |
| Coconut | Palm | Tilapia | palmitic acid | and OPO | fatty | fatty | Triglyc- | similarity |
| oil | oil | oil | (%) | (%) | acids | acid | eride | score |
| 19% | 1% | 80% | 59.82 | 41.06 | 88.28 | 80.11 | 72.17 | 80.19 |
| 15% | 10% | 75% | 51.59 | 41.45 | 89.88 | 81.60 | 76.47 | 82.65 |
| 15% | 20% | 65% | 42.84 | 39.63 | 92.56 | 78.33 | 76.24 | 82.38 |
| 15.77% | 19.26% | 64.9% | 43.18 | 39.37 | 92.73 | 78.28 | 76.47 | 82.49 |
| 20% | 20% | 60% | 41.11 | 37.08 | 93.72 | 75.13 | 76.24 | 81.69 |

### Example 8: Human Milk Fat Substitute Composition

Palm kernel oil, palm oil and tilapia oil prepared in example 1 were selected as the base oils. Under different ratios of palm kernel oil, palm oil and tilapia oil, the similarity of total fatty acids, sn-2 fatty acids and triglycerides in human milk fat substitute composition with Chinese breast milk fat are shown in table 6.

When the optimal ratio of palm kernel oil:palm oil:tilapia oil was 18.57%: 18.47%: 62.96%, the content of sn-2 palmitic acid in the breast milk substitute composition was 34.59%. The content of sn-2 palmitic acid accounted for 45.03% of the total palmitic acid. The sum of OPO and OPL accounted for 38.51% of the total triglyceride content. The similarity scores of total fatty acids, sn-2 fatty acid and triglyceride were 93.40, 80.39 and 89.42 respectively, and the total similarity score was 87.74. Sun Cong determined commercially available infant formula milk powder oils. The similarity scores of total fatty acids, sn-2 fatty acids and triglycerides with Chinese breast milk fat are 56.12, 33.51 and 17.51, and the total similarity score is 35.72. Compared with the commercial human milk fat substitutes in infant formulas, the prepared human milk fat substitute composition in present invention has higher overall similarity with Chinese human milk fat, and also have higher similarity in sn-2 fatty acid composition and triglyceride composition.

TABLE 6
Score results of human milk fat substitutes obtained from different
palm kernel oil, palm oil and tilapia oil compositions

| | | | The | The sum | | | | |
|---|---|---|---|---|---|---|---|---|
| | | | percentage of | of the | | | | |
| Composition | | | sn-2 palmitic | contents | Score | | | |
| Palm | | | acid in total | of OPL | Total | Sn-2 | | Total |
| Kernel | Palm | Tilapia | palmitic acid | and OPO | fatty | fatty | Triglyc- | similarity |
| Oil | Oil | Oil | (%) | (%) | acids | acid | eride | score |
| 19% | 1% | 80% | 62.59 | 41.50 | 88.12 | 83.70 | 86.42 | 86.08 |
| 15% | 10% | 75% | 53.49 | 41.80 | 88.53 | 83.59 | 88.68 | 86.93 |
| 15% | 20% | 65% | 44.53 | 39.97 | 92.54 | 79.02 | 88.26 | 86.61 |
| 18.57% | 18.47% | 62.96% | 45.03 | 38.53 | 93.40 | 80.39 | 89.42 | 87.74 |
| 20% | 20% | 60% | 43.42 | 37.54 | 93.63 | 79.23 | 89.03 | 87.29 |

### Example 9: Human Milk Fat Substitute Composition

Coconut oil, soybean oil and tilapia oil prepared in example 1 were selected as the base oil. Under different ratios of coconut oil, soybean oil and tilapia oil, the similarity of total fatty acids, sn-2 fatty acids and triglycerides in human milk fat substitute composition with Chinese human milk fat are shown in table 7. When the ratio of coconut oil:soybean oil:tilapia oil was 20%: 20%: 60%, the sn-2 palmitic acid content in the obtained human milk fat substitute composition is 29.78%. The content of sn-2 palmitic acid accounted for 52.60% of the total palmitic acid. The sum of OPO and OPL accounted for 33.35% of total triglycerides. The similarity scores of total fatty acids, sn-2 fatty acid and triglyceride were 88.91, 70.80 and 70.59 respectively, and the total similarity score was 76.77. Sun Cong determined commercially available infant formula milk powder oils. The similarity scores of total fatty acids, sn-2 fatty acids and triglycerides with Chinese breast milk fat are 56.12, 33.51 and 17.51, and the total similarity score is 35.72. Compared with the commercial human milk fat substitutes in infant formulas, the prepared human milk fat substitute composition in present invention has higher overall similarity with Chinese human milk fat, and also has higher similarity in sn-2 fatty acid composition and triglyceride composition.

TABLE 7
Score results of human milk fat substitutes obtained by different
coconut oil, soybean oil and tilapia oil compositions

| | | | The | The sum | | | | |
|---|---|---|---|---|---|---|---|---|
| | | | percentage of | of the | | | | |
| | | | sn-2 palmitic | contents | Score | | | |
| Composition | | | acid in total | of OPL | Total | Sn-2 | | Total |
| Coconut | Soybean | Tilapia | palmitic acid | and OPO | fatty | fatty | Triglyc- | similarity |
| oil | oil | oil | (%) | (%) | acids | acid | eride | score |
| 19% | 1% | 80% | 60.64 | 40.88 | 87.96 | 79.63 | 70.59 | 79.39 |
| 15% | 5% | 80% | 60.40 | 41.44 | 87.24 | 80.88 | 70.59 | 79.57 |
| 15% | 10% | 75% | 58.56 | 39.59 | 87.52 | 78.75 | 70.59 | 78.95 |
| 15% | 15% | 70% | 56.60 | 37.74 | 87.81 | 76.62 | 70.59 | 78.34 |
| 20% | 20% | 60% | 52.60 | 33.35 | 88.91 | 70.80 | 70.59 | 76.77 |

### Example 10: Human Milk Fat Substitute Composition

Palm kernel oil, OPO structural fat and tilapia oil fractionated product prepared in example 4 were selected as base oil. Under different ratios of palm kernel oil, OPO structural fat and tilapia oil fractionated product, the similarity of total fatty acids, sn-2 fatty acids and triglycerides in human milk fat substitute composition with Chinese breast milk fat are shown in table 8. When the ratio is palm kernel oil:OPO structural fat:tilapia oil fraction was 5%: 20%: 75%, the sn-2 palmitic acid content in human milk fat substitute composition is 50.38%. The content of sn-2 palmitic acid accounted for 56.79% of the total palmitic acid. The sum of OPO and OPL accounted for 59.81% of total triglycerides. The similarity scores of total fatty acids, sn-2 fatty acids and triglycerides with Chinese breast milk fat were 96.32, 55.20 and 75.30, and the total similarity score was 75.60. Sun Cong determined commercially available infant formula milk powder oils. The similarity scores of total fatty acids, sn-2 fatty acids and triglycerides with Chinese breast milk fat are 56.12, 33.51 and 17.51, and the total similarity score is 35.72. Compared with the commercial human milk fat substitutes in infant formulas, the prepared human milk fat substitute composition in present invention has higher overall similarity with Chinese human milk fat. At the same time, the similarity of human milk fat substitutes in sn-2 fatty acid composition and triglyceride composition is significantly improved.

TABLE 8
Score results of human milk fat substitutes composed of palm kernel
oil, OPO structural fat and tilapia oil fractionated product

| | | | The | The sum | | | | |
|---|---|---|---|---|---|---|---|---|
| | | | percentage of | of the | | | | |
| Composition | | | sn-2 palmitic | contents | Score | | | |
| Palm | OPO | Tilapia oil | acid in total | of OPL | Total | Sn-2 | | Total |
| Kernel | Structural | fractionated | palmitic acid | and OPO | fatty | fatty | Triglyc- | similarity |
| Oil | Fat | product | (%) | (%) | acids | acid | eride | score |
| 5% | 20% | 75% | 56.78 | 55.09 | 96.32 | 55.20 | 73.36 | 74.96 |
| 10% | 15% | 75% | 56.98 | 52.80 | 97.07 | 62.26 | 77.45 | 78.93 |
| 15% | 10% | 75% | 57.20 | 50.52 | 97.82 | 69.32 | 81.28 | 82.19 |
| 15% | 5% | 80% | 57.88 | 51.15 | 96.79 | 75.41 | 82.34 | 84.85 |
| 19% | 1% | 80% | 58.11 | 49.32 | 96.49 | 80.46 | 83.51 | 86.82 |

### Example 11: Human Milk Fat Substitute Composition

Palm kernel oil, palm oil, OPO structural fat and tilapia oil extracted from example 1 were selected as base oil. The similarity of total fatty acids, sn-2 fatty acids and triglycerides in the human milk fat substitute composition obtained under different palm kernel oil, palm oil, OPO structural fat and tilapia oil ratios with Chinese breast milk fat are shown in table 9.

The optimal ratio of palm kernel oil:palm oil:OPO structural fat:tilapia oil was 18.57%: 18.47%: 0.11%: 62.86%, the content of sn-2 palmitic acid in the human milk fat substitute composition is 34.60%. The sn-2 palmitic acid accounts for 45.02% of the total palmitic acid content. The sum of OPO and OPL accounted for 38.53% of total triglycerides. The similarity scores of total fatty acids, sn-2 fatty acids and triglycerides with Chinese breast milk fat were 93.43, 80.28 and 89.39, and the total similarity score was 87.70. Sun Cong determined commercially available infant formula milk powder oils. The similarity scores of total fatty acids, sn-2 fatty acids and triglycerides with Chinese breast milk fat are 56.12, 33.51 and 17.51, and the total similarity score is 35.72. Compared with the commercial human milk fat substitutes in infant formulas, the prepared human milk fat substitute composition in present invention has higher overall similarity with Chinese human milk fat. At the same time, the similarity of human milk fat substitutes in sn-2 fatty acid composition and triglyceride composition is significantly improved.

TABLE 9
Score results of human milk fat substitutes composed of palm
kernel oil, palm oil, OPO structural fat and tilapia oil

| | | | | The | The sum | | | | |
|---|---|---|---|---|---|---|---|---|---|
| | | | | percentage of | of the | | | | |
| Composition | | | | sn-2 palmitic | contents | Score | | | |
| Palm | | OPO | | acid in total | of OPL | Total | Sn-2 | | Total |
| Kernel | Palm | Structural | Tilapia | palmitic acid | and OPO | fatty | fatty | Triglyc- | similarity |
| Oil | Oil | Fat | Oil | (%) | (%) | acids | acid | eride | score |
| 10% | 5% | 5% | 80% | 58.29 | 44.99 | 87.77 | 77.43 | 86.57 | 83.92 |
| 10% | 10% | 5% | 75% | 53.48 | 44.08 | 89.11 | 76.09 | 86.57 | 83.92 |
| 15% | 10% | 5% | 70% | 52.61 | 41.65 | 91.54 | 77.36 | 88.68 | 85.68 |
| 15% | 10% | 1% | 74% | 53.31 | 41.77 | 90.20 | 81.15 | 88.68 | 86.68 |
| 15% | 15% | 1% | 69% | 48.67 | 40.85 | 91.54 | 79.61 | 88.68 | 88.61 |
| 18.57% | 18.47% | 0.11% | 62.86% | 45.02 | 38.51 | 93.43 | 80.28 | 89.39 | 87.70 |

### Example 12: Human Milk Fat Substitute Composition

Soybean oil, peanut oil, palm oil, coconut oil and tilapia oil prepared in example 1 are selected as the base oil. The ratio soybean oil:peanut oil:palm oil:coconut oil:tilapia oil was 0.70%: 5.60%: 15.96%: 17.92%: 59.83%. The sn-2 palmitic acid content in the human milk fat substitute composition is 31.39%. The content of sn-2 palmitic acid accounted for 42.76% of the total palmitic acid. The sum of OPO and OPL accounted for 37.03% of total triglycerides. The similarity scores of total fatty acids, sn-2 fatty acids and triglycerides of the human milk fat substitute composition were 95.21, 74.82 and 76.47, and the total similarity score was 82.17. Sun Cong determined commercially available infant formula milk powder oils. The similarity scores of total fatty acids, sn-2 fatty acids and triglycerides with Chinese breast milk fat are 56.12, 33.51 and 17.51, and the total similarity score is 35.72. Compared with the commercial human milk fat substitutes in infant formulas, the prepared human milk fat substitute composition in present invention has higher overall similarity with Chinese human milk fat. At the same time, the similarity of human milk fat substitutes in sn-2 fatty acid composition and triglyceride composition is significantly improved.

### Example 13: Human Milk Fat Substitute Composition

Soybean oil, peanut oil, palm oil, coconut oil, basa catfish oil and tilapia oil prepared in example 1 are selected as base oils. The ratio of soybean oil:peanut oil:palm oil:coconut oil:basa catfish oil:tilapia oil was 1.02%: 2.87%: 0.46%: 18.15%: 27.79%: 49.72%, and the similarity scores of its total fatty acids, sn-2 fatty acids and triglycerides are 96.78, 79.52 and 83.05 respectively, and the total average score is 86.45. At present, the total similarity score of human milk fat substitutes in infant formulas in the Chinese market is below 60 points (Sun Cong. Composition, similarity evaluation and preparation of human milk fat substitutes [D]: [Doctoral dissertation]. Wuxi: Jiangnan University, 2018). Therefore, the present invention significantly improves the similarity between human milk fat substitutes and Chinese human milk fat.

### Example 14: Human Milk Fat Substitute Composition

Soybean oil, peanut oil, palm oil, palm kernel oil, MLCT structural lipid and the tilapia oil fraction prepared in example 4 are selected as the base oil. The ratio of soybean oil:peanut oil:palm oil:palm kernel oil:MLCT structural lipid:tilapia oil fractionated product was 5%: 5%: 5%: 15%: 10%: 60%, the sn-2 palmitic acid content in the human milk fat substitute composition is 38.49%, and the content of sn-2 palmitic acid accounted for 50.23% of the total palmitic acid. The sum of OPO and OPL accounted for 41.03% of total triglycerides. The similarity scores of total fatty acids, sn-2 fatty acids and triglycerides of the human milk fat substitute composition were 98.28, 79.96 and 94.13, and the total similarity score was 90.79. Sun Cong determined commercially available infant formula milk powder oils. The similarity scores of total fatty acids, sn-2 fatty acids and triglycerides with Chinese breast milk fat are 56.12, 33.51 and 17.51, and the total similarity score is 35.72. Compared with the commercial human milk fat substitutes in infant formulas, the prepared human milk fat substitute composition in present invention has higher overall similarity with Chinese human milk fat. At the same time, the similarity of human milk fat substitutes in sn-2 fatty acid composition and triglyceride composition is significantly improved.

### Example 15: Human Milk Fat Substitute Composition

Soybean oil, peanut oil, palm oil, OPL structural grease, MLCT structural grease and tilapia oil fraction extracted from example 1 were selected as base oil. The ratio of soybean oil:peanut oil:palm oil:OPL structural fat:MLCT structural fat:tilapia oil was 10%: 5%: 10%: 15%: 10%: 50%, the sn-2 palmitic acid content in the human milk fat substitute composition is 34.95%, and the content of sn-2 palmitic acid accounted for 43.94% of the total palmitic acid. The sum of OPO and OPL accounted for 39.13% of total triglycerides. The similarity scores of total fatty acids, sn-2 fatty acids and triglycerides of the human milk fat substitute composition were 93.59, 64.28 and 92.72, and the total similarity score was 83.53. Sun Cong determined commercially available infant formula milk powder oils. The similarity scores of total fatty acids, sn-2 fatty acids and triglycerides of the human milk fat substitute composition are 56.12, 33.51 and 17.51, and the total similarity score is 35.72. Compared with the commercial human milk fat substitutes in infant formulas, the prepared human milk fat substitute composition in present invention has higher overall similarity with Chinese human milk fat. At the same time, the similarity of human milk fat substitutes in sn-2 fatty acid composition and triglyceride composition is significantly improved.

The total fatty acid, sn-2 fatty acid and triglyceride composition of natural oils and modified oils are shown in table 10-12.

TABLE 10
Total fatty acid composition of natural oils and modified oils (%)

| | | | | | Palm | Basa | OPO | OPL | MLCT |
|---|---|---|---|---|---|---|---|---|---|
| Fatty | Soybean | Peanut | Palm | Coconut | kernel | catfish | structural | structural | structural |
| acid | oil | oil | oil | oil | oil | oil | lipid | lipid | lipid |
| C10:0 | ND | ND | ND | 5.76 | 3.17 | ND | ND | ND | 2.01 |
| C12:0 | ND | ND | ND | 46.86 | 47.14 | ND | 1.16 | ND | 20.23 |
| C14:0 | ND | ND | 0.94 | 18.69 | 16.39 | 4.12 | 1.09 | ND | 9.06 |
| C16:0 | 11.84 | 11.20 | 47.01 | 9.70 | 8.83 | 33.83 | 39.65 | 34.26 | 27.94 |
| C16:1 | 0.10 | 0.08 | ND | ND | 0.00 | 1.37 | 0.05 | ND | ND |
| C18:0 | 3.93 | 3.03 | 4.23 | 2.92 | 2.29 | 9.04 | 6.67 | 3.88 | 3.11 |
| C18:1 | 25.45 | 48.34 | 34.02 | 7.10 | 16.25 | 40.69 | 46.08 | 33.85 | 25.48 |
| C18:2 | 52.69 | 33.37 | 13.21 | 1.84 | 2.71 | 9.90 | 4.39 | 28.01 | 10.41 |
| C18:3 | 5.49 | 1.20 | 0.56 | ND | 0.08 | 1.04 | 0.06 | ND | ND |

Note:
ND means not detected.

TABLE 11
Composition of sn-2 fatty acid of natural oil and modified oil (%)

| | | | | | Palm | Basa | OPO | OPL | MLCT |
|---|---|---|---|---|---|---|---|---|---|
| Fatty | Soybean | Peanut | Palm | Coconut | kernel | catfish | structural | structural | structural |
| acid | oil | oil | oil | oil | oil | oil | lipid | lipid | lipid |
| C12:0 | ND | ND | ND | 71.08 | 53.44 | ND | 1.40 | ND | 25.09 |
| C14:0 | ND | ND | 0.29 | 10.54 | 18.69 | 2.88 | 1.39 | ND | 7.1 |
| C16:0 | 2.44 | 1.75 | 13.30 | 2.41 | 10.27 | 50.65 | 59.51 | 34.26 | 41.46 |
| C16:1 | ND | ND | ND | ND | ND | 1.06 | 4.41 | ND | ND |
| C18:0 | 1.28 | 0.60 | 1.03 | 1.09 | 2.91 | 5.52 | 28.21 | 3.88 | 3.27 |
| C18:1 | 25.36 | 50.97 | 59.58 | 10.48 | 8.51 | 28.79 | 4.83 | 33.85 | 16.21 |
| C18:2 | 66.41 | 46.51 | 25.60 | 3.66 | 1.92 | 10.57 | 0.24 | 28.01 | 6.11 |

TABLE 12
Composition of triglyceride of natural oil and modified oil (%)

| | | | | | Palm | Basa | OPO | OPL | MLCT |
|---|---|---|---|---|---|---|---|---|---|
| Triglyc- | Soybean | Peanut | Palm | Coconut | kernel | catfish | structural | structural | structural |
| erides | oil | oil | oil | oil | oil | oil | lipid | lipid | lipid |
| LaLaO | ND | ND | ND | 1.43 | 5.05 | ND | ND | ND | ND |
| CaPL | ND | ND | ND | ND | ND | ND | ND | ND | ND |
| LLL | 13.18 | 7.92 | ND | ND | ND | ND | ND | ND | ND |
| LaOL | ND | ND | ND | ND | ND | ND | ND | ND | 3.76 |
| CaPO | ND | ND | ND | ND | ND | ND | ND | ND | 1.00 |
| OLL | 20.22 | 16.06 | ND | ND | ND | 0.62 | 2.06 | ND | ND |
| LPL | 14.93 | 5.04 | 1.33 | ND | ND | ND | 18.77 | ND | 0.60 |
| MOL | ND | ND | ND | ND | ND | 1.00 | ND | ND | 1.08 |
| LaOO | ND | ND | ND | ND | 4.12 | ND | ND | ND | 5.99 |
| POLa | ND | ND | ND | ND | 4.73 | ND | ND | ND | 6.69 |
| OPL | 12.91 | 11.03 | 12.00 | ND | ND | 14.39 | 57.96 | 3.23 | 2.99 |
| PPL | 1.45 | 0.93 | 14.71 | ND | ND | ND | 2.66 | 1.55 | 0.54 |
| MPO | ND | ND | ND | ND | 2.19 | 1.41 | ND | ND | 4.63 |
| OOO | 2.17 | 28.28 | 1.05 | ND | 2.18 | 5.73 | 0.25 | 3.71 | 0.92 |
| OPO | 1.10 | 11.38 | 20.64 | ND | 2.29 | 27.25 | 13.62 | 44.71 | 3.98 |
| PPO | ND | 1.28 | 41.91 | ND | 1.77 | 20.04 | 2.11 | 39.29 | 4.46 |
| POS | 0.21 | 2.56 | ND | ND | 0.54 | 6.56 | 0.27 | 4.56 | 1.00 |

Note:
ND means not detected.

### Example 16: Formula Milk Powder for Infants and Young Children

An infant formula milk powder containing the human milk fat substitute composition in example 14. Its composition includes (in parts by weight): 300 parts of skimmed cow/goat milk, 200 parts of whey powder, 15 parts of whey protein powder, 80 parts of oil for infant formula milk powder, 5 parts of phospholipids, 1 part of DHA powder, 1 part of arachidonic acid powder, 40 parts of white sugar, 40 parts of lactose, 20 parts of glucose, 0.5 parts of sialic acid, 0.5 parts of nucleotides, 3 parts of choline, 0.1 parts of lutein, 1 part of multi-vitamin and 1 part of multi-mineral.

### Example 17: Formula Milk Powder for Middle-Aged and Elderly People

A milk formula for middle-aged and elderly people containing the fat composition in example 14. Its composition includes (in parts by weight): 300 parts of skimmed milk powder, 100 parts of whey protein powder, 40 parts of oil for infant formula milk powder, 20 parts of white sugar, 20 parts of lactose, 20 parts of glucose, 0.5 parts of DHA powder, 0.5 parts of arachidonic acid powder, 0.5 parts of sialic acid, 0.5 parts of nucleotides, 0.3 parts of taurine, 0.1 parts of lutein, 1 part of complex vitamins and 1 part of complex minerals.

### Example 18: A Kind of Swine Feed

The contents of palmitic acid, oleic acid and linoleic acid in sow milk were 22.94%, 34.50% and 22.81%, respectively. (Bai Y S, et al. Effects of fat sources in sow on the fatty acid profiles and fat globule size of milk and immunoglobulins of sows and piglets. 2017, 234:217-227.) It can be seen from the main fatty acids that it is very similar to the fatty acid composition of tilapia oil. As mentioned earlier, tilapia oil is beneficial to the digestion and absorption due to the location and distribution of fatty acids. Therefore, tilapia oil can be used as a good source of fat for swine feed.

A swine feed, the feed comprising: 9% tilapia oil, 25% fish meal, 25% crushed soybean meal, 20% whey powder, 20% spray blood meal, 0.5% vitamins and 0.5% minerals, based on mass percentage.

### Example 19

Using mice as a model to study the effect of fish oil on its lipid metabolism. The details are as follows:

Laboratory animal clean-grade Wistar rats (1 week old, male), raised in a clean-grade laboratory animal center, temperature (23+2° C.), humidity 60%, free drinking and eating. The care and pretreatment of laboratory animals are carried out in accordance with the relevant provisions of the “Regulation on the Administration of Laboratory Animals”. After preparing 21 male Wistar rats fed with basic feed for one week, they were randomly divided into 3 groups, namely the experimental group (addition of tilapia oil), the control group (addition of silver carp oil) and the basic control group (addition of palm oil). After a week of adaptation, they began to feed according to the feed formula. The feed formulas of each group are formulated with reference to the experimental animal feed formula recommended by the American Nutrition Society. The fat sources of the feeds of each group are different. Energy and various main nutrients, minerals and various trace elements are consistent. Change bedding and drinking water daily. The young rats were fed separately in the metabolic cage for 2 weeks, and the average food intake and weight gain were recorded.

TABLE 13
Basic dietary formula for young rats

| | Experimental | Control | Basic control |
|---|---|---|---|
| Ingredient | group | group | group |
| Source of fat | Tilapia Oil | Silver Carp Oil | Palm Oil |
| Fat | 20 g | 20 g | 20 g |

| | | | |
|---|---|---|---|
| Other | Sucrose | 10 | g |
| ingredients | Casein | 25 | g |
| | Corn starch | 20 | g |
| | Maltodextrin | 15 | g |
| | Cysteine | 0.25 | g |
| | Cellulose | 5 | g |
| | Choline | 0.25 | g |
| | Bitartrate | | |
| | Vitamin | 1 | g |
| | mixture | | |
| | Mineral | 3.5 | g |
| | mixture | | |

The feeding experiment was carried out for two weeks, and the feces of the last three days were collected in time. At the end of each day, the collected fecal samples were weighed and frozen at −20° C. After the end of the experiment period, all the fecal samples of each cage were mixed and mixed, and a part of them was frozen and dried, crushed and crushed to 40 mesh sieve, and then frozen for storage at −20° C. The composition of lipid and mineral in feces of mice was determined. The results are shown in table 14 and table 15.

TABLE 14
Dietary intake and growth status of mice

| | Experimental | Control | Basic control |
|---|---|---|---|
| Index | group | group | group |
| Dietary intake (g/14 d) | 210.32 ± 2.11 | 213.47 ± 2.41 | 213.66 ± 1.98 |
| Weight gain (g/14 d) | 79.83 ± 1.74 | 72.41 ± 1.66 | 62.46 ± 1.78 |
| Fecal volume (g/3 d) | 4.23 ± 0.23 | 4.16 ± 0.14 | 4.11 ± 0.17 |

During the two-week feeding experiment, the body weight of laboratory mice containing tilapia oil had a certain increasing trend compared with the other two groups. In addition, the feces of the mice in the control group and the basic control group were darker in color and had lower water content.

The apparent absorption rate of fat and minerals in mice is shown in table 15. Compared with the control group and the basic control group, the experimental group has a better apparent fat absorption rate. It can be seen that tilapia oil is more conducive to the absorption of fat. There was no significant difference in the apparent absorptivity of magnesium among the three groups. The apparent absorption rate of calcium in the experimental group was significantly higher than the other two groups, which may be due to palmitic acid located in sn-1, 3 position, easy to combine with calcium to form calcium soap. While the solubility of calcium soap in bile was low, and the fat and calcium in the soap were difficult to be absorbed. Therefore, tilapia oil can reduce the excretion of calcium in feces and improve the absorption of calcium.

TABLE 15
Apparent absorption rate of fat and minerals in mice

| | Experimental | Control | Basic control |
|---|---|---|---|
| Item | group | group | group |
| Apparent fat absorption | 95.10 ± 2.21 | 87.21 ± 1.94 | 82.34 ± 1.39 |
| rate (%) | | | |
| Ca apparent absorption | 57.43 ± 1.02 | 48.64 ± 0.98 | 39.71 ± 1.14 |
| rate (%) | | | |
| Mg apparent absorption | 44.31 ± 0.78 | 42.57 ± 0.94 | 40.23 ± 0.86 |
| rate (%) | | | |

Note:
Apparent absorption rate = (intake − fecal content)/intake × 100%

Comparison 1: Other Fish Oil

According to the chloroform methanol method in example 1, silver carp oil, grass carp oil, carp oil and bream oil were extracted. The contents of palmitic acid, oleic acid, linoleic acid and sn-2 palmitic acid in these four fish oils were determined as shown in table 16. It can be seen from table 16 that compared with breast milk fat, the fatty acid composition of these four fish oils is little different, but the location distribution is quite different, especially the content of OPO and OPL. This is far from the Chinese breast milk fat composition, and it is not suitable as a base oil to prepare breast milk replacement fat.

TABLE 16
Comparison of lipid composition (%)

| | | | | sn-2 | | |
|---|---|---|---|---|---|---|
| | Palmitic | | linoleic | palmitic | | |
| | acid | Oleic acid | acid | acid | OPL | OPO |
| Fish oil | content | content | content | content | content | content |
| Silver carp | 18.47 | 21.22 | 8.42 | 31.87 | 4.21 | 14.53 |
| oil | | | | | | |
| Grass carp | 15.24 | 32.67 | 34.96 | 21.52 | 5.72 | 10.44 |
| oil | | | | | | |
| Carp oil | 16.88 | 24.26 | 24.37 | 30.04 | 7.94 | 9.65 |
| Bream oil | 16.27 | 34.76 | 30.42 | 21.51 | 10.11 | 11.44 |
| Tilapia oil | 24.27 | 33.90 | 21.48 | 48.01 | 31.94 | 14.71 |
| Tilapia oil | 26.43 | 29.07 | 19.32 | 52.47 | 36.25 | 19.03 |
| fractionated | | | | | | |
| product | | | | | | |
| Wuxi | 20.15 ± 1.68 | 32.71 ± 2.57 | 19.43 ± 2.81 | 51.65 ± 3.43 | 28.08 ± 3.26 | 19.50 ± 3.91 |
| breast milk | | | | | | |
| fat (Xia yuan, | | | | | | |
| 2015) | | | | | | |

Comparison 2: Evaluation of Lipid in a Swine Feed

The fatty acid composition in the commercial swine feed is determined. It was found that the contents of palmitic acid, oleic acid and linoleic acid were 14.64%, 36.39% and 37.52%, respectively. Compared with the sow milk fat in the above example, the fatty acid composition is larger. The content of oleic acid and linoleic acid in feed is higher, mostly from vegetable oil. Palmitic acid in vegetable oil is mostly distributed in sn-1,3 position, which is not conducive to fat digestion and absorption.

Comparison 3: Evaluation of Lipids in a Commercially Available Infant Formula Milk Powder

Weigh 1 g of commercially available vegetable oil-based infant formula A, add 10 ml of 65° C. hot water, mix well and cool. Add 2.0 ml ammonia water, mix it well, put it into a water bath at about 65° C., heat it for 15-20 min, take it out from time to time and shake it. Remove, and cool to room temperature. Add 10 ml ethanol and mix gently but thoroughly. Add 25 mL of ether and petroleum ether for extraction. After layering, take the upper organic phase and repeat 2-3 times. All the organic phases were combined, the organic solvent was removed by rotary evaporation at 40° C., and the fat was stored in the refrigerator at −20° C. The contents of palmitic acid, oleic acid and linoleic acid were 15.78%, 39.72% and 18.70%, and the content of sn-2 palmitic acid was 11.48%. The contents of OPO and OPL were 12.21% and 5.98% respectively. The scores of total fatty acids, sn-2 fatty acid and triglyceride were 85.35, 23.62 and 33.68 respectively, and the total similarity score was 47.55. Compared with the human milk fat substitutes of infant formula milk powder in the embodiment of the invention, the score loss in sn-2 fatty acid and triglyceride is more.

Comparison 4: Evaluation of Lipid in a Commercial Infant Formula

Weigh 1 gram of commercially available milk/vegetable oil-based infant formula B, add 10 mL of 65° C. hot water, mix well and cool. Add 2.0 mL ammonia water, mix well, put it in a water bath at about 65° C., heat it for 15-20 min, take it out and shake it from time to time. Remove, and cool to room temperature. Add 10 ml ethanol and mix gently but thoroughly. Add 25 mL of ether and petroleum ether for extraction. After layering, take the upper organic phase and repeat 2-3 times. All the organic phases were combined, the organic solvent was removed by rotary evaporation at 40° C., and the fat was stored in the refrigerator at −20° C. The palmitic acid, oleic acid, linoleic acid content of the total fatty acids of the commercially available infant formula milk powder were 20.19%, 29.22% and 25.45%, and the sn-2 palmitic acid content was 33.94%. The contents of OPO and OPL are 10.31%, 0, respectively. The scores of total fatty acids, sn-2 fatty acids and triglycerides were 66.91, 37.03 and 9.79 respectively, and the total similarity score was 37.91. Compared with the human milk fat substitutes of the infant formula milk powder in the embodiment of the invention, the score loss in sn-2 fatty acid and triglyceride is more.

Comparison 5: Evaluation of Lipid in a Commercial Infant Formula

Weigh 1 gram of commercially available goat milk/vegetable oil-based infant formula C, add 10 mL of 65° C. hot water, mix well and cool. Add 2.0 mL ammonia water, mix well, put it in a water bath at about 65° C., heat it for 15-20 min, take it out and shake it from time to time. Remove, and cool to room temperature. Add 10 ml ethanol and mix gently but thoroughly. Add 25 mL of ether and petroleum ether for extraction. After layering, take the upper organic phase and repeat 2-3 times. All the organic phases were combined, the organic solvent was removed by rotary evaporation at 40° C., and the fat was stored in the refrigerator at − 20° C. The palmitic acid, oleic acid, and linoleic acid content of the total fatty acids of the commercially available infant formula milk powder were 15.65%, 29.18% and 21.43%, and the sn-2 palmitic acid content was 26.31%. The contents of OPO and OPL are 9.66%, 0, respectively. The scores of total fatty acids, sn-2 fatty acid and triglyceride were 65.82, 30.29 and 45.82 respectively, and the total similarity score was 47.31. Compared with the human milk fat substitutes of the infant formula milk powder in the embodiment of the invention, the score loss in sn-2 fatty acid and triglyceride is more.

Though the present invention with preferred embodiment openly as above; right it is not in order to qualification the present invention, any people who is familiar with this technology, without departing from the spirit and scope of the present invention; all can do various changes and modification, so protection scope of the present invention should be with being as the criterion that claims were defined.

What is claimed is:

1. A human milk fat substitute composition, wherein the composition is prepared by using tilapia oil or its fractionated product thereof as a base oil, and added with one or more natural oils and/or modified oils.

2. The human milk fat substitute composition of claim 1, wherein the one or more natural oils are lipids extracted from animals and plants.

3. The human milk fat substitute composition of claim 2, wherein the natural oils comprise soybean oil, peanut oil, palm oil, palm kernel oil, coconut oil, or basa catfish fish oil, or any combination thereof, and wherein the modified oils comprise 1,3-dioleoyl-2-palmitoylglycerol (OPO) structured lipid, 1-oleoyl-2-palmitoyl-3-linoleoylglycerol (OPL) structured lipid, or medium-and-long chain triacylglycerol (MLCT) structured lipid, or any combination thereof.

4. The human milk fat substitute composition of claim 1, wherein the human milk fat substitute composition comprises 1-50% by mass of the natural oils and/or modified oils and 50-99% by mass of the tilapia oil or its fractionated product thereof.

5. The human milk fat substitute composition of claim 3, wherein the percentage of palmitic acid in sn-2 position accounts for 40%-70% by mass of the total palmitic acid, and the sum of OPO and OPL accounts for 30%-65% by mass of the total triglyceride content; preferably the percentage of sn-2 position palmitic acid is 40%-60% by mass of the total palmitic acid, and the sum of OPO and OPL accounts for 30%-55% by mass of the total triglyceride content.

6. The human milk fat substitute composition of claim 4, wherein the human milk fat substitute composition comprises the following with respect to mass percentage of:
1%-20% of coconut oil and 80%-99% of tilapia oil or the fractionated product thereof; preferably 10%-20% of coconut oil and 80%-90% of tilapia oil or the fractionated product thereof; or
1%-20% of palm kernel oil and 80%-99% of tilapia oil or the fractionated product thereof; preferably 10%-20% of palm kernel oil and 80%-90% of tilapia oil or the fractionated product thereof; or
10%-20% of coconut oil, 1%-20% of palm oil and 60%-80% of tilapia oil or the fractionated product thereof; or
10%-20% of palm kernel oil, 1%-20% of palm oil and 60-80% of tilapia oil or the fractionated product thereof; or
10%-20% of coconut oil, 1%-20% of soybean oil and 60-80% of tilapia oil or the fractionated product thereof; preferably 10%-20% of coconut oil, 1%-10% of soybean oil and 70-80% of tilapia oil or the fractionated product thereof; or
1%-20% of palm kernel oil, 1%-20% of OPO structured lipids and 60-80% of tilapia oil or the fractionated product thereof; preferably 10%-20% of palm kernel oil, 1%-10% of OPO structured lipids and 70-80% of tilapia oil or the fractionated product thereof; or
1%-20% of palm kernel oil, 1%-20% palm oil, 0%-10% of OPO structured lipids and 50-80% of tilapia oil or the fractionated product thereof; preferably 10%-20% of palm kernel oil, 10%-20% palm oil, 0%-5% of OPO structured lipids and 55-80% of tilapia oil or the fractionated product thereof; or
0%-10% of peanut oil, 0%-10% of soybean oil, 10%-20% of palm oil, 10%-20% of coconut oil and 50%-80% of tilapia oil or the fractionated product thereof; or
0%-10% of soybean oil, 0%-10% of peanut oil, 0%-10% of palm oil, 5%-15% of palm kernel oil, 0%-25% of modified oil and 50%-70% of tilapia oil or the fractionated product thereof; or
0%-10% of soybean oil, 0%-10% of peanut oil, 0%-10% palm oil, 10%-20% of coconut oil, 0%-30% of basa catfish fish oil, 0%-5% of OPL structured lipids, and 40%-70% of tilapia oil or the fractionated product thereof.

7. A food or milk powder having the human milk fat substitute composition of claim 1.

8. A method of using tilapia oil or its fractionated product thereof in preparation of human milk fat substitutes or dairy products.

9. A method of using tilapia oil or fractionated product thereof in preparation of swine feeds.

10. A swine feed, wherein the swine feed comprises tilapia oil or fractionated product thereof, proteins, carbohydrates, minerals and vitamins.

11. The swine feed of claim 10, wherein the proteins comprise soybean meal, blood meal, fish meal, and whey protein powder, or any combination thereof, and wherein the carbohydrates comprise lactose, whey powder, and oligosaccharide, or any combination thereof.

12. The swine feed of claim 11, wherein the swine feed comprises 5-15% by mass of tilapia oil or the fractionated product thereof, 20-30% by mass of fish meal, 20-30% by mass of soybean meal, 10-20% by mass of whey powder, 15-25% by mass of blood meal, 0-1% by mass of vitamin and 0-1% by mass of mineral.
